(19) United States
(12) Patent Application Publication
(10) Pub. No.: US 2022/0218570 A1
(43) Pub. Date: Jul. 14, 2022

(54) TEETHER

(71) Applicant: LISA STAHL, ROCKFORD, MI (US)

(72) Inventor: LISA STAHL, ROCKFORD, MI (US)

(21) Appl. No.: 17/147,739

(22) Filed: Jan. 13, 2021

(51) Int. Cl. A61J 17/00; A47G 21/00

(52) U.S. Cl. CPC A61J 17/10; A61J 17/1115; A47G 21/001

(57) ABSTRACT

A teether is disclosed that is capable of retaining and presenting solid, cold, and/or damp food to a teething child. The teether has a top piece and a bottom piece. An opening in the top piece has a plurality of lobes and a like number of retaining teeth. The retaining teeth are configured to capture properly sized food, so that a teething child is able to gum or gnaw on the food, but not remove the food from the teether. If the child places too much force on the food, the food falls through the opening into a vessel, where is remains until removed by an adult.

### CLAIM OF PRIORITY

None.

### FIELD OF INVENTION

This invention relates to one or more classifications and sub-classifications for devices for administering food or medicine and baby comforters. Specifically, this invention is a baby teether capable of retaining and presenting hard foods to a child during teething.

### BACKGROUND OF INVENTION

According to the CDC, infants are defined as children under the age of one, and toddlers are defined as children between the ages of one and three. Teething is a process that all children experience, that straddles the infant and toddler stages of development. At about three months, babies start putting things in their mouths, resulting in the child drooling. This is usually the first sign that a child is teething. According to the American Academy of Pediatrics (“AAP”), most children get their first tooth around 6 months of age and have a complete set of 20 deciduous teeth by 30 months of age.

As the AAP states, the information most new parents receive about teething, and the symptoms surrounding it, are ill-defined and nonevidence-based. The symptoms most associated with teething are fussiness, drooling, changes in sleep and eating patterns, runny nose (aka rhinorrhea), rash, and diarrhea. The most accurate way to determine if a child is teething is to examine their gums. If the gums have isolated swelling, redness, or soreness, the child is teething.

The AAP suggests that a child experiencing teething pain be given solid, cold, and damp items to chew on. The AAP specifically rejects liquid- or gel-filled rings, numbing gels, homeopathics, and amber necklaces as treatments for teething pain.

As most parents know, there is no perfect solution to teething, because no item satisfies all three of the attributes given by the AAP. Gel-filled teething rings, which can be placed in the freezer, are not recommended because they are not solid. Solid teething rings are not generally effective, because they are not cold and damp. Many foods, such as hard apples, cucumbers, and similar fruits and vegetables meet the AAP's guidelines, but teething children often lack the dexterity to grasp the wet and slippery surfaces of such foods. What parents really need for their teething children is a product that securely captures cold, damp, solid food stuffs in a way that allow infants and toddlers to hold it and gum on it.

### SUMMARY OF THE INVENTION

This summary is intended to disclose the present invention, a teether. Embodiments of the invention are presented to illustrate and inform one skilled in the art. The teether captures cold, damp, solid food, such as apples, cucumbers, pears, and carrots, and presents it to a teething child in a manner in which the child can grasp and manipulate.

The present invention, a teether, is comprised of two pieces: a top piece and a bottom piece, that mate when used. The top piece has an outer top surface, an outer cylindrical surface, and a flange. The flange bisects the outer cylindrical surface, creating an upper cylindrical surface and a lower cylindrical surface. The outer top surface has an inner side. The upper cylindrical surface is orthogonal to, and terminates at, the outer top surface. The lower cylindrical surface terminates at a bottom opening, which is disposed distal to the outer top surface. Both the upper cylindrical surface and the lower cylindrical surface abut the flange. The bottom opening mates with the bottom piece. The outer cylindrical surface has an inner cylindrical surface, disposed oppositely. A retention lip is formed in the inner cylindrical surface in order to capture the bottom piece.

The top piece has an opening in its outer top surface, created by a continuous edge. The continuous edge traces out a plurality of lobes which are connected by a like number of rounded teeth. In other words, if there are two lobes, there are two teeth; if there are four lobes, there are four teeth. In the exemplary embodiment, the continuous edge traces out four lobes which are connected by four rounded teeth. In the exemplary embodiment, the four lobes and four rounded teeth are symmetrical and identical, but that is not a requirement. When there are four lobes and four teeth, which are identical and symmetrical, the opening in the outer top surface resembles a plus sign.

The bottom piece is comprised of a vessel, a stem, and a base. The vessel is open at the top. On the outer surface of the vessel, in near proximity to the opening, is a retention rim. The vessel opening and retention ring of the bottom piece mate with the bottom opening and retention lip of the top piece. The retention ring in the bottom piece is captured by the retention lip on the inner cylindrical surface of the top piece, joining the top piece and the bottom piece.

A piece of food can be inserted into the rounded teeth of the opening of the top piece. Preferably, the food is solid, cold, and damp, such as an apple slice, a cucumber slice, a pear slice, or a carrot slice. A wedge-shaped piece of food works best, although food with many different form factors will work, such as cross-sectional slices, vertical slices, rectangles, squares, discs, and ellipsoids. The food is pressed into the opening between the rounded teeth. This can be done from the top—from the outer top surface—or it can be done from the bottom—from the inner side of the outer top surface. In order to place food into the opening from the bottom, the top piece is separated from the bottom piece. The piece of food is inserted into the rounded teeth of the opening in the top piece from the inner side of the outer top surface. The top piece and the bottom piece are then combined so that the retention ring is captured by the retention lip. The teething child may gnaw on the food, the flange of the top piece, the stem, or the base.

The teether is ideally fabricated as two mating pieces from a rigid, inert structural plastic such as polypropylene (“PP”), virgin high-density polyethylene (“HDPE”), and Polyethylene Terephthalate (“PET”). Some materials, like acrylonitrile butadience styrene (“ABS”), should be avoided because the material is not approved for food containers by the FDA, as it contains hazardous substances in its raw form. Some materials, like Polycarbonate (“PC”), are approved for use with food, but many parents are leery of Bisphenol-A which can leach out of PC. Polylactic acid (“PLA”) should also be avoided, because its biodegradable nature makes it unsafe for a teether for young children. PLA will leach its constituent parts when repeatedly exposed to saliva. The material for the teether should not leach due to saliva. Portions of the present invention can be textured or use a rubberized surface. The stem can be textured or it can use a rubberized material to improve the grip or to make it a more desirable surface for gnawing. Likewise, the flange and the base can be textured or rubberized so as to encourage gnawing. The teeth of the top piece can be fabricated from stiff thermoplastic elastomers.

### BRIEF DESCRIPTION OF THE DRAWINGS

The present invention is illustrated with 6 drawings on 3 sheets. The accompanying drawings, which are incorporated in and constitute a part of this disclosure, illustrate various example embodiments. In the drawings:

FIG. 1 is a top view of the top piece of the present invention.

FIG. 2 is a side view of the top piece of the present invention.

FIG. 3 is a perspective side view of the bottom piece of the present invention.

FIG. 4 is a perspective view of the top and bottom piece combined into the present invention.

FIG. 5 is side vertical cut-away, showing the inside of the top and bottom piece combined into the present invention.

FIG. 6 is a perspective view of the top and bottom piece combined into the present invention, with a piece of food for teething installed.

### DETAILED DESCRIPTION OF THE DRAWINGS

The following descriptions are not meant to limit the invention, but rather to add to the summary of invention, and illustrate the present invention, a teether. The present invention is illustrated with a variety of drawings showing the primary embodiments of the present invention, with various diagrams and figures explaining its workings.

Certain terminology is used in the following description for convenience only and is not limiting. The article “a” is intended to include one or more items, and where only one item is intended the term “one” or similar language is used. To assist in the description of the present invention, words such as short, long, top, bottom, side, upper, lower, front, rear, inner, outer, right and left are used to describe the relative size and orientation of the present invention, a teether, with respect to the accompanying figures. The terminology includes the words above specifically mentioned, derivatives thereof, and words of similar import.

The following detailed description refers to the accompanying drawings. Wherever possible, the same reference numbers are used in the drawings and the following description to refer to the same or similar elements. The embodiments of the claimed subject matter may be described, modified, and adapted, and other implementations are possible. For example, substitutions, additions, or modifications, which, perform identical functions to the embodiments disclosed, may be made to the elements illustrated in the drawings. Accordingly, the following detailed description does not limit the claimed subject matter. The proper scope of the claimed subject matter is defined by the claims contained herein. The claimed subject matter improves over the prior art by providing a teether that allows a child to teeth on solid, cold, and damp food.

Looking at FIG. 4, the present invention 1 has a top piece 2 and a bottom piece 3.

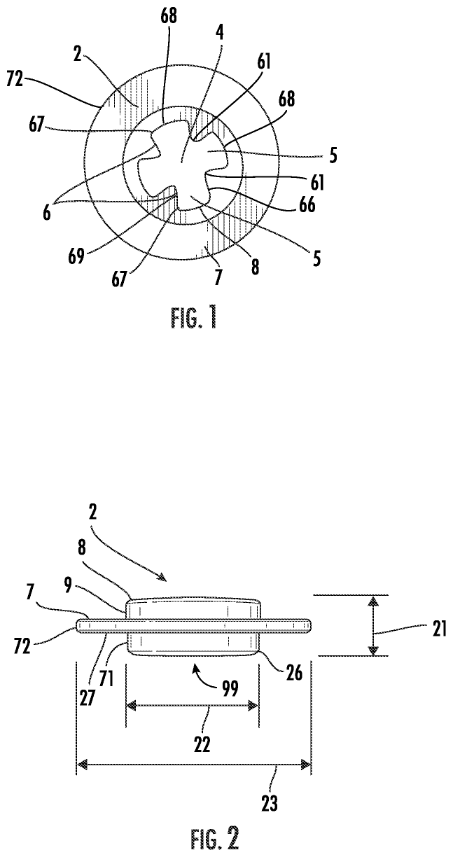

FIGS. 1-2 show the top piece 2 in detail. FIG. 1 is a top view of the top piece 2. FIG. 2 is a side view of the top piece 2. The top piece 2 has an outer top surface 8, an annular flange 7, and an outer cylindrical surface 9, 71. The cylindrical surface 9, 71 is bisected by the annular flange 7, creating an upper cylindrical surface 9, and a lower cylindrical surface 71. The upper cylindrical surface 9 is orthogonal to the outer top surface 8 and the flange 7; the lower cylindrical surface 71 is orthogonal to the flange 7.

The top piece 2 has a height 21, a first diameter 22, and a second diameter 23. The first diameter 22 is the diameter 22 of the outer cylindrical surface 9, 71. The upper cylindrical surface 9 terminates at the top outer surface 8. The lower cylindrical surface 71 terminates in an opened rim 26. The upper cylindrical surface 9 and the lower cylindrical surface 71 both abut the flange 7. The opened rim 26 of the top piece 2 mates with the bottom piece 3. The second diameter 23 is the outer perimeter 72 of the flange 7. The flange 7 has a top surface 7 and a bottom surface 27.

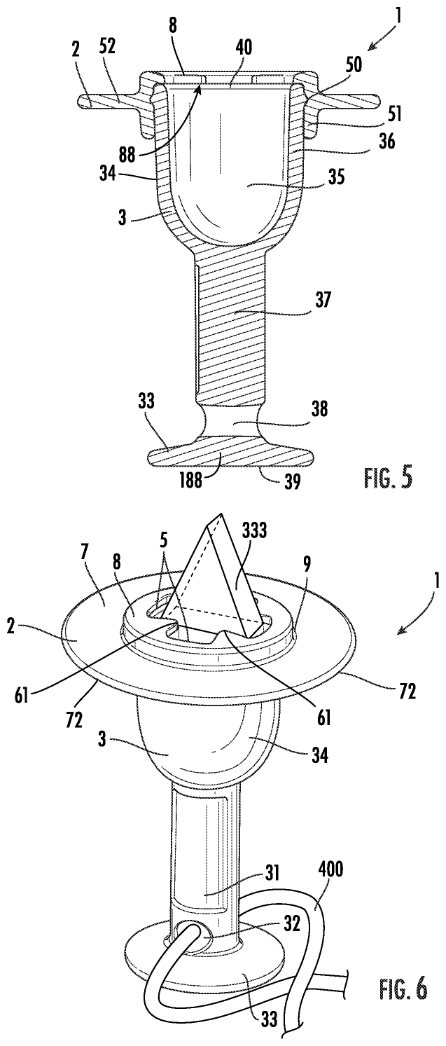

The top piece 2 has an opening 4 in its top surface 8, through which a piece of solid, cold, and/or damp food 333 can be presented to a teething child [See FIG. 6]. The opening 4 resembles a plus sign 4. The opening 4 is defined by a continuous edge 6 in the top surface 8. The opening 4 has plurality of lobes 5. The plurality of lobes 5 are connected with a like number of rounded teeth 61. In the exemplary embodiment, as shown in FIGS. 1 and 2, the opening 4 has four lobes 5. The four lobes 5 are connected by four rounded teeth 61. Each lobe 5 is defined by three edge segments 65, 67, 66 connected by two fillet segments 69, 68. The four rounded teeth 61 connecting the four lobes 5 serve the function of retention teeth 61 for pieces of food 333 inserted into the opening 4. The retention teeth 61 hold and retain hard, cold, and/or damp food 333, so that a child may gnaw on the food 333 to relieve the discomfort of teething.

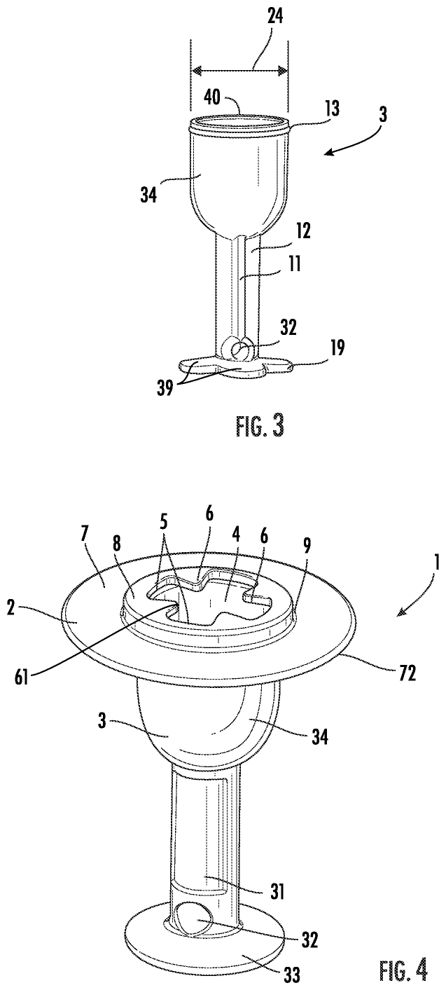

FIG. 3 shows the bottom piece 3. The bottom piece 3 has a vessel 34, a stem 11, 12, and a base 19. In this embodiment, the stem 11, 12 is constructed from orthogonally joined planar members 11, 12. The base 19 has defined feet 39. An optional opening 32 can be placed in the stem 11, 12 or foot 19, to attach a tether 400 to the teether 1. The bottom piece 3 has an opening 40 to the inside of the vessel 34. The bottom piece 3 has a diameter 24 defining the size of the opening 40. The vessel 34 has an exterior surface 34. The bottom piece 3 has a retention rim 13, which mates with a retention lip molded to the inner cylindrical surface of the top piece 2.

FIGS. 4 and 5 show the present invention 1, a teether, with the top piece 3 and bottom piece 4 in place. FIG. 4 is a perspective view; FIG. 5 is a side vertical cut-away. The top piece 2 has an outer top surface 7, a flange 7, and a side surface 9. There is an opening 4 is the outer top surface 8. The opening 4 has four lobes 5 and four retention teeth 61. The retention teeth 61 are fabricated from a stiff but flexible material.

The lower piece 3 has a vessel 34, a stem 31, and a base 33. In this embodiment, the stem 31 is cylindrical as is the outer diameter of the base 33. An opening 32 in the stem 31 allows for the attachment of a retaining tether 400. The interior 35 of the vessel 34 of the bottom piece 3 is designed to receive pieces of food 333, if pushed through the retention teeth 61 in the opening 4 of the top piece 2. The opening 40 in the bottom piece 3 allows for the food to fall through the retention teeth 61 where it is retained in the interior 35 of the vessel 34 of the bottom piece 3.

As shown in FIG. 5, the stem 31 is solid 37. The vessel 34 has a thickness 36. The flange 7 has a thickness 52. The lower surface 71 has a thickness 51. The base 33 has a thickness 188 and a bottom surface 39. The inner surface of the top piece 2 has a lip 50 that captures the retention rim 13 of the lower piece 3. The opening 32 in the stem 33 is a cylinder 38 with an interior cylindrical surface 38. A tether 400 can pass through the stem and secure the teether 1. The outer top surface 8 of the top piece 2 has an inner top surface 88, which is oriented towards the interior 35 of the vessel 34 when the two pieces 2, 3 are mated

FIG. 6 shows the present invention 1, a teether 1, retaining a piece of solid, cold, and/or damp food 333. To insert food 333, the food 333 is pressed into the retention teeth 61 from the top. Alternately, food 333 can be inserted into the retention teeth 61 from the bottom. The top piece 2 is separated from the bottom piece 3. A piece of food 333 is firmly inserted into the teeth 61 in the opening 4, from the inner-top-surface side 88 of the outer top surface 8. When the food is firmly retained by the teeth 61, the top piece 2 is mated with the bottom piece 3, by aligning the outer diameter of the opening 24 of the bottom piece 3 with the first diameter 22 of the top piece 2. The top piece 2 and bottom piece 3 are then pressed together until the lip 50 in the top piece engages and captures the retention rim 13 of the bottom piece 3. The food 333 is retained by the retention teeth 61 in the opening 4 in the top piece 2.

When a child teeths on the food 333, the food 333 will remain in place. If the child presses the food 333 with too much force, the food 333 will land in the interior 35 of the vessel 34. In this way, the teether 1 can be used to present appropriate food 333 to a teething child, while eliminating the hazard of choking. Food 333 cannot be pulled out through the retaining teeth 61 by a teething child under normal conditions. Said another way, the retention force exerted by the retention teeth 61 on the food 333 makes it so that the food 333 can be driven into the interior 35 of the vessel 34 of the bottom piece 3 but cannot be extracted outward, away from the vessel 34. If a child should drive the food 333 into the interior 35 of the vessel 34, the food 333 will remain in the interior 35 of the vessel 34 until removed by an adult. The teether 1 also prevents the child from abandoning half-teethed food stuff all around a house.

The teether is ideally fabricated as two mating pieces from a rigid, inert structural plastic such as PP, virgin HDPE, and PET. Some materials, like ABS, should be avoided because the material is not approved for food containers by the FDA, as it contains hazardous substances in its raw form. Some materials, like PC, are approved for use with food, but many parents are leery of Bisphenol-A which can leach out of PC. Therefore, one skilled in the art may wish avoid PC, although PC has the material properties with which to form the present invention 1. PLA should also be avoided, because its biodegradable nature makes it unsafe for a teether for young children. PLA will leach its constituent parts when repeatedly exposed to saliva. The material for the teether 1 should not leach due to saliva.

Portions of the present invention can be textured or use a rubberized surface. The stem 11, 12, 31 can be textured or it can use a rubberized material to improve the grip. The teeth 61 of the top piece 2 can be fabricated from stiff structural plastics or from stiff thermoplastic elastomers.

Embodiments described above with reference to functions or acts, comprise methods. The functions/acts noted above may occur out of the order as shown or described. For example, two functions/acts shown or described in succession may in fact be executed substantially concurrently or the functions/acts may sometimes be executed in the reverse order, depending upon the functionality/acts involved. While certain embodiments have been described, other embodiments may exist. Further, the disclosed methods' functions/acts may be modified in any manner, including by reordering functions/acts and/or inserting or deleting functions/acts, without departing from the spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I claim:

1. A teether comprising:
a bottom piece having an opened vessel with an interior and exterior, a retention rim about the exterior of the vessel near the opening of the vessel, a stem, and a base;
a top piece having a top surface with an inner and outer side, a cylindrical surface, orthogonal to the top surface, with an inner and outer side, and a flange with a top side and a bottom side;
wherein the top piece is capable of fitting over and mating to the bottom piece;
wherein the top surface has a continuous edge defining an opening with a plurality of lobes connected by a like number of retention teeth;
wherein the opening with the plurality of lobes and retention teeth is capable of capturing and retaining properly sized food so that the food may be gummed or gnawed by a teething child.

2. The teether of claim 1, wherein there are four lobes and four retention teeth.

3. The teether of claim 2, wherein the four lobes and four retention teeth are identical and symmetrical.

4. The teether of claim 3, wherein the opening resembles a plus sign.

5. The teether of claim 4, wherein the retention teeth are rounded.

6. The teether of claim 5, wherein the top piece has a retention lip on its inner cylindrical surface.

7. The teether of claim 6, wherein the retention lip engages the retention rim, mating the top piece with the bottom piece and holding the two pieces together.

8. The teether of claim 7, wherein the top piece may be separated from the bottom piece by pulling the two pieces apart from one another.

9. The teether of claim 8, wherein the flange of the top piece bisects the outer cylindrical surface of the top piece, defining an upper cylindrical surface and a lower cylindrical surface.

10. The teether of claim 9, wherein the retention force exerted by the retention teeth on the food makes it so that the food can be driven into the interior vessel of the bottom piece but cannot be extracted outward, away from the vessel.

11. The teether of claim 10, wherein the top piece is fabricated from at least one of polypropylene (“PP”), virgin high-density polyethylene (“HDPE”), Polyethylene Terephthalate (“PET”) and a thermoplastic elastomer (“TPE”).

12. The teether of claim 11, wherein the bottom piece is fabricated from at least one of PP, virgin HDPE, PET, and TPE.

13. The teether of claim 12, wherein the flange is textured.

14. The teether of claim 12, wherein the flange is coated with a TPE.

15. The teether of claim 12, wherein the base is textured.

16. The teether of claim 12, wherein the base is coated with TPE.

17. The teether of claim 12, wherein the stem is textured.

18. The teether of claim 12, wherein the stem is coated with TPE

19. The teether of claim 12, wherein the stem is formed from to orthogonally intersecting vertical planar members.

20. The teether of claim 12, wherein the base is formed with a plurality of feet.

21. The teether of claim 12, wherein the stem has a through-hole intended for use with a tether.
